(19) United States
(12) Patent Application Publication
(10) Pub. No.: US 2025/0337452 A1
(43) Pub. Date: Oct. 30, 2025

(54) METHOD FOR SECURING TRANSMISSION OF THE IDENTIFIER OF A PORTABLE DEVICE FOR ACCESSING A MOTOR VEHICLE

(71) Applicant: Continental Automotive Technologies GmbH, Hannover (DE)

(72) Inventors: Amaia FORTES MONTILLA, Muret (FR); Guilherme Germano BUCHMEIER, Toulouse (FR); Mohamed Cheikh, Toulouse (FR)

(73) Assignee: Continental Automotive Technologies GmbH, Hannover (DE)

(21) Appl. No.: 19/063,997

(22) Filed: Feb. 26, 2025

(30) Foreign Application Priority Data
Apr. 30, 2024 (FR) FR2404489

(51) Int. Cl. H04B 1/40

(52) U.S. Cl. CPC H04B 1/40

(57) ABSTRACT

A method for securing the transmission of the identifier of a portable device for accessing a motor vehicle. The vehicle includes an electronic control unit, the device including a control module, the method includes the steps of the management module commanding transmission of a high-frequency signature request and its characteristics, the vehicle receiving the high-frequency signature request, the vehicle generating a high-frequency signature, sending the generated high-frequency signature to the device, the device analyzing the received high-frequency signature, the control module sending a signal containing an identifier if the high-frequency signature has the expected characteristics, the vehicle receiving the sent signal, the vehicle identifying the device and activating a function of the vehicle.

### CROSS REFERENCE TO RELATED APPLICATIONS

This application claims priority to French Application No. FR2404489, filed Apr. 30, 2024, the contents of such application being incorporated by reference herein.

### FIELD OF THE INVENTION

The present invention pertains to the field of motor vehicles, and relates more particularly to a method for securing the transmission of the identifier of a portable device for controlling a vehicle.

### BACKGROUND OF THE INVENTION

For convenience reasons, an increasing number of motor vehicle functions may be carried out remotely by a user using a portable device. Contactless unlocking thus allows a user equipped with a portable access device, such as a key or badge, to open the vehicle remotely when approaching.

This contactless unlocking takes place through the exchange of radiofrequency (RF) waves between the device and the vehicle. In the general case, when the vehicle detects the device, the vehicle sends a message to the device, which sends back its identifier in return. Once the vehicle receives the identifier, an on-board electronic control unit commands unlocking of the opening elements.

However, this unlocking method is vulnerable to hacking attempts, in particular what are known as “relay” attacks, when the user is away from the vehicle. These attacks consist in recording and retransmitting the signals exchanged between the vehicle and the device so as to force detection while they are away from one another, and trigger the sending of the identifier. Equipped with this identifier, a third party is then able to unlock a vehicle in the absence of the user and enter it to steal objects or steal the vehicle.

Multiple techniques have been developed to strengthen the security of radiofrequency exchanges.

For example, the vehicle may measure the strength of the received signal to determine whether the signal is being transmitted by the user's device or by a third party attempting a relay attack on the vehicle. However, these techniques are complex because the strength of the signal may vary greatly between legitimate situations, for example if the user has their device in a pocket, close to a metal object, etc.

Other techniques consist in disabling the vehicle module that analyzes radiofrequency waves so as to shield it from hacking attempts, based in particular on the movement and distance of the user device. However, disabling the module is effective only in some cases, and does not work with regard to protecting the vehicle in other cases, for example if the relay attack occurs while the user is moving or before the module goes into standby mode.

The vehicle module may also record the relative positions of the user device so as to derive therefrom a trajectory of the user and determine the legitimacy of the received signals. However, this technique is complex because the module has to be able to analyze highly different approach trajectories in order to determine those corresponding to the legitimate user and those related to hacking attempts.

A simple, reliable and effective solution for at least partly overcoming these disadvantages therefore would be advantageous.

### SUMMARY OF THE INVENTION

To this end, the invention relates firstly to a method for securing the transmission of the identifier of a portable device for accessing a motor vehicle, said vehicle comprising an electronic control unit, a radiofrequency antenna module and a high-frequency antenna module, said device comprising a control module, a radiofrequency antenna module and a high-frequency antenna module, said control module comprising a memory area in which the identifier of said device is stored, said method comprising the following steps:
the control module of the device commanding transmission of a high-frequency signature request via the radiofrequency antenna module of the device, said high-frequency signature request comprising the characteristics of said signature,
the electronic control unit receiving the high-frequency signature request via the radiofrequency antenna module of the vehicle,
the electronic control unit generating a high-frequency signature containing the characteristics,
sending the generated high-frequency signature to the device via the high-frequency antenna module of the vehicle,
the control module receiving the sent high-frequency signature via the high-frequency antenna module of the device,
the control module analyzing the received high-frequency signature,
when the high-frequency signature has the characteristics sent in the high-frequency signature request, the control module sending a signal containing the identifier via the radiofrequency antenna module of the device, the electronic control unit receiving the sent signal via the radiofrequency antenna module of the vehicle, the electronic control unit identifying the device and activating at least one function of the vehicle once the device has been identified.

The method according to the invention thus makes it possible to secure the transmission of the identifier to the vehicle by the device by implementing, beforehand, an exchange of a high-frequency signature request and the high-frequency signature. High-frequency signals have a reduced range compared to other types of radiofrequency signals, and thus limit the chance of a third party having a capture device for receiving and repeating the received signals. The prior exchange also makes it possible to secure the device because, if a fraudulent command to transmit the identifier is received by the device, said device will not transmit the identifier since no high-frequency signature was received beforehand. This protection also covers the eventuality whereby a third party transmits a fraudulent high-frequency signature that does not correspond to any high-frequency signature request sent beforehand.

Preferably, the electronic control unit temporarily keeps the receipt of the high-frequency signature request in memory and, when the device is identified by the electronic control unit, identifies the device only if the identifier has been received and the electronic control unit still has the receipt of the high-frequency signature request in memory. Thus, even if a third party has managed to steal the identifier of the device, it is not able to activate the functions of the vehicle without having triggered the exchange of a high-frequency signature request and a high-frequency signature beforehand.

According to another aspect, the invention relates to a method for securing the transmission of the identifier of a portable device for accessing a motor vehicle, said method being implemented by the device, said device comprising a control module, a radiofrequency antenna module and a high-frequency antenna module, said control module comprising a memory area in which the identifier of said device is stored, said method comprising the following steps:
the control module of the device commanding transmission of a high-frequency signature request via the radiofrequency antenna module of the device, said high-frequency signature request comprising the characteristics of said signature,
the control module receiving a sent high-frequency signature via the high-frequency antenna module of the device,
the control module analyzing the received high-frequency signature,
when the high-frequency signature has the characteristics sent in the high-frequency signature request, the control module sending a signal containing the identifier via the radiofrequency antenna module of the device.

According to another aspect, the invention relates to a method for securing the transmission of an identifier of a portable device for accessing a motor vehicle, said method being implemented by the vehicle, said vehicle comprising an electronic control unit, a radiofrequency antenna module and a high-frequency antenna module, said method comprising the following steps:
the electronic control unit receiving a high-frequency signature request via the radiofrequency antenna module of the vehicle, said high-frequency signature request comprising the characteristics of said signature,
the electronic control unit generating a high-frequency signature containing the characteristics,
sending the generated high-frequency signature via the high-frequency antenna module of the vehicle,
the electronic control unit receiving a signal containing the identifier via the radiofrequency antenna module of the vehicle,
the electronic control unit identifying the identifier and activating a function of the vehicle.

Advantageously, the vehicle comprises a locking system connected to the electronic control unit and the function of the vehicle activated in the step of identifying the device during the method according to the invention is that of unlocking the locking system of the vehicle.

As an alternative, the function of the vehicle activated in the step of identifying the device may be that of starting the engine, activating the air conditioning, etc.

In one preferred mode of operation, the control module triggers a timer when the high-frequency signature request is sent, stops the timer when the high-frequency signature is received, compares the time thus measured with a reference time and triggers the step of analyzing the signature only if the measured time is less than the reference time. This timer makes it possible to identify a legitimate exchange between the vehicle and the device carried by the user. If a third party attempts to capture the radiofrequency signature and retransmit it, the delay that is generated causes a lag that thus blocks the method, preventing fraudulent capture of the identifier.

Preferably, the values of the characteristics of the high-frequency signature request are generated randomly each time the method is implemented. Thus, if the high-frequency signature is captured by a third party during an exchange between the vehicle and the device, it cannot be reused later.

Again preferably, the high-frequency signature request is a square-wave signal the characteristics of which comprise the number of square waves, their duration and/or their spacing. The high-frequency signature may thus be a PWM (pulse-width modulation) signal. This type of signal is easy to transmit and does not cause excessive power consumption either for the stopped vehicle or for the device.

In one preferred embodiment, the high-frequency antenna module of the vehicle and the high-frequency antenna module of the device each comprise a high-frequency antenna, the two antennas being mutually resonant. Resonant is understood to mean that the two antennas transmit and receive signals at the same frequency. Thus, if a third party seeks to use a device that does not have an antenna the resonant frequency of which corresponds to that of the resonant antenna of the vehicle and of the device, the resulting signal will be heavily scrambled and therefore difficult to identify and/or exploit.

Again preferably, the two resonant antennas have a high quality factor, preferably greater than or equal to 80. The high quality factor makes it possible to ensure signal quality over a longer range. Thus, if a third party seeks to use a device having an antenna with a low quality factor to recover the sent high-frequency signal, the signal will be heavily scrambled unless the third party is very close to the user's device or the vehicle.

Advantageously, the method as presented comprises evaluating the quality of the signal during the step of the control module analyzing the high-frequency signature, the control module blocking the method if the signal is of poor quality. The control module thus detects a fraudulent attempt through the poor quality of the signal and prevents the transmission of the identifier.

The invention also relates to a device comprising a control module, a radiofrequency antenna module and a high-frequency antenna module, said control module comprising a memory area in which an identifier is stored and being configured to:
be connected to the radiofrequency antenna module and to the high-frequency antenna module in the device,
command transmission of a high-frequency signature request via the radiofrequency antenna module, said high-frequency signature request comprising the characteristics of said high-frequency signature,
receive a sent high-frequency signature via the high-frequency antenna module,
analyze the received high-frequency signature,
when the high-frequency signature has the characteristics sent in the high-frequency signature request, send a signal containing the identifier via the radiofrequency antenna module of the device.

The invention also relates to an electronic control unit for a motor vehicle, said electronic control unit being configured to:
be connected to a radiofrequency antenna module and a high-frequency antenna module,
receive a high-frequency signature request via the radiofrequency antenna module of the vehicle, said high-frequency signature request comprising the characteristics of said signature,
generate a high-frequency signature containing the characteristics,
send the generated high-frequency signature via the high-frequency antenna module of the vehicle,
receive a signal containing the identifier via the radiofrequency antenna module of the vehicle,
identify the identifier and activate a function of the vehicle.

The invention also relates to a vehicle comprising an electronic control unit as presented, a radiofrequency antenna module and a high-frequency antenna module.

The invention also relates to a system comprising the vehicle as presented and a portable access device as presented, said system making it possible to implement the method according to the invention.

### BRIEF DESCRIPTION OF THE DRAWINGS

Further features and advantages of the invention will become more clearly apparent upon reading the following description. This description is purely illustrative and should be read with reference to the attached drawings, in which:

FIG. 1 schematically illustrates a system comprising a vehicle and a device configured to implement the method according to the invention.

FIG. 2 schematically illustrates one embodiment of the method according to the invention.

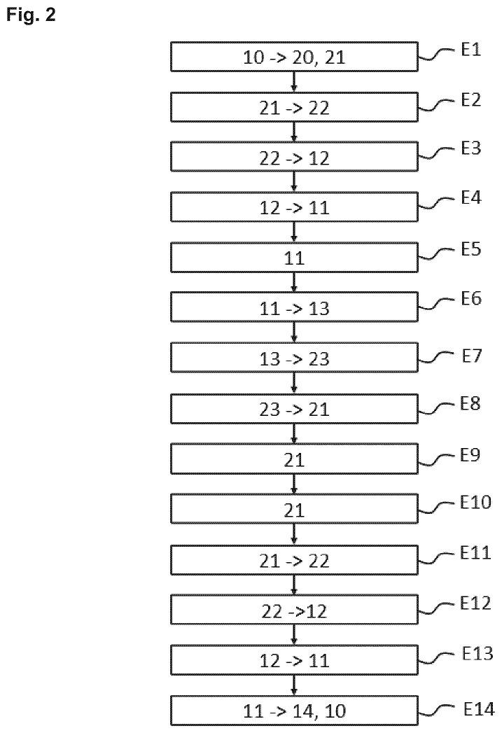

### Detailed Description of Exemplary Embodiments

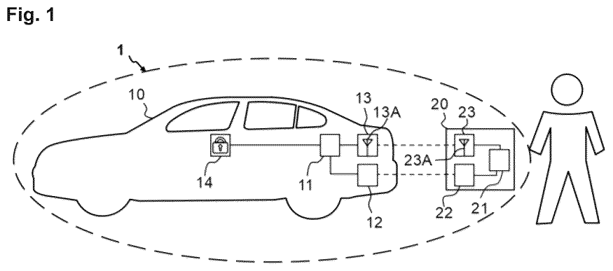

FIG. 1 shows a system 1 implementing the method for securing the transmission of the identifier of a portable device 20 for accessing a motor vehicle 10.

### System 1

As shown in FIG. 1, the system 1 comprises a vehicle 10 and a device 20 carried by a user of the vehicle 10.

### Vehicle 10

The vehicle 10 comprises an electronic control unit 11, a radiofrequency antenna module 12, a high-frequency antenna module 13 and a locking system 14.

In a manner known per se, the vehicle 10 comprises a plurality of antennas intended to regularly transmit detection signals in order to detect the presence of the device 20 in the vicinity of the vehicle 10. These antennas are not shown in the figures for reasons of clarity.

These detection signals are low-frequency signals of around 100 kHz that are transmitted regularly.

### Electronic Control Unit 11

The electronic control unit 11 is configured to be connected to the radiofrequency antenna module 12, to the high-frequency antenna module 13 and to the locking system 14.

The electronic control unit 11 is configured to receive a high-frequency signature request via the radiofrequency antenna module 12 of the vehicle 10, said high-frequency signature request comprising the characteristics of said signature.

The electronic control unit 11 is configured to generate a high-frequency signature containing the characteristics, and to send the generated high-frequency signature via the high-frequency antenna module 13 of the vehicle 10.

The electronic control unit 11 may send the high-frequency signature multiple times to guarantee complete receipt.

Advantageously, the electronic control unit 11 may decrypt the high-frequency signature request if the signature request has been encrypted beforehand by the control module 21, and encrypt the high-frequency signature to be transmitted.

The electronic control unit 11 is configured to keep the receipt of the high-frequency signature request and/or the generation of the high-frequency signature in memory for a limited time.

The electronic control unit 11 is configured to receive a signal containing an identifier via the radiofrequency antenna module 12 of the vehicle 10.

The electronic control unit 11 is configured to identify the identifier.

The electronic control unit 11 is configured to send a signal to the locking system 14.

In addition or as an alternative, the electronic control unit 11 is configured to send a signal to activate another function of the vehicle 10, for example to start the engine of the vehicle 10 or activate the air conditioning.

### Radiofrequency Antenna Module 12

The radiofrequency antenna module 12 of the vehicle 10 makes it possible to transmit and receive radiofrequency signals between 200 MHz and 500 MHZ, preferably between 300 MHz and 450 MHz.

The radiofrequency antenna module 12 of the vehicle 10 makes it possible to send radiofrequency signals to the device 20 carried by the user of the vehicle 10.

The radiofrequency antenna module 12 of the vehicle 10 is configured to receive radiofrequency signals transmitted by the device 20 carried by the user.

### High-Frequency Antenna Module 13

The high-frequency antenna module 13 comprises a resonant antenna 13A.

The high-frequency antenna module 13 is configured to transmit a square-wave radiofrequency signal to the high-frequency antenna module 23 of the device 20.

The radiofrequency signal is transmitted in the high-frequency range, that is to say between 3 MHz and 30 MHz.

### Resonant Antenna 13A

The resonant antenna 13A is the electronic component that makes it possible to transmit the radiofrequency signal.

The resonant antenna 13A has a high quality factor, preferably greater than or equal to 80.

The resonant antenna 13A is configured to receive a radiofrequency signal at a precise frequency, for example 14 MHz, corresponding to the resonant frequency of the resonant antenna 23A present in the high-frequency antenna module 23 of the device 20.

### Locking System 14

The locking system 14 makes it possible to block and release the opening of the opening elements of the vehicle 10 according to the user's commands.

When the locking system 14 receives the appropriate identifier, the locking system 14 triggers releasing of the opening of the opening elements of the vehicle 10.

A user may then open an opening element of the vehicle 10 to enter inside.

The locking system 14 may be targeted by attacks by malicious third parties wishing to fraudulently enter the vehicle 10.

### Device 20

The user has the device 20 to hand. The device 20 makes it possible to release the opening elements of the vehicle 10 by sending an identifier.

The device 20 may be present on the key of the vehicle 10, or be a separate accessory.

The device 20 comprises a control module 21, a radiofrequency antenna module 22 and a high-frequency antenna module 23.

In a manner known per se, the device 20 is configured to receive the detection signals transmitted by the vehicle 10.

### Control Module 21

The control module 21 comprises a memory area in which the identifier enabling the opening of the opening elements of the vehicle 10 is stored.

The control module 21 is configured to be connected to the radiofrequency antenna module 22 of the device 20 and to the high-frequency antenna module 23 of the device 20.

The control module 21 is configured to command transmission of a high-frequency signature request via the radiofrequency antenna module 22.

The high-frequency signature request comprises the characteristics of said signature.

Preferably, the high-frequency signature is a square-wave signal, or a PWM (pulse-width modulation) signal the characteristics of which comprise the number of square waves, their duration and/or their spacing.

For example, the expected characteristics of the high-frequency signature may be “4 square waves of 10 ms spaced by 50 ms”.

The characteristics of the high-frequency signature are generated randomly so that the high-frequency signature is unique from one use to another.

Advantageously, the control module 21 may encrypt the high-frequency signature request in order to reduce the risk of it being intercepted.

The control module 21 is configured to receive a sent high-frequency signature via the high-frequency antenna module 23.

If the high-frequency signature sent by the vehicle 1 is encrypted, the control module 21 is configured to decrypt the encrypted high-frequency signature.

The control module 21 is configured to analyze the received high-frequency signature by comparing the characteristics of the received high-frequency signature with that of the request transmitted by the device 20.

The control module 21 is configured to also take into account the quality of the signal containing the high-frequency signature.

The control module 21 is configured to send a signal containing the identifier via the radiofrequency antenna module 22 of the device 20.

The control module 21 is configured to have a reference time in memory, to start and stop a timer and to compare the value of the timer when it is stopped with the stored reference time.

### Radiofrequency Antenna Module 22

The radiofrequency antenna module 22 of the device 20 makes it possible to transmit and receive radiofrequency signals between 200 MHz and 500 MHZ, preferably between 300 MHz and 450 MHZ.

The radiofrequency antenna module 22 of the device 20 is configured to send a radiofrequency signal to the locking system 14 of the vehicle 10 comprising the identifier that makes it possible to release the opening elements.

### High-Frequency Antenna Module 23

The high-frequency antenna module 23 comprises a resonant antenna 23A.

The high-frequency antenna module 23 is configured to receive a square-wave radiofrequency signal transmitted by the high-frequency antenna module 23 of the vehicle 10.

The radiofrequency signal is transmitted in the high-frequency range, that is to say between 3 MHz and 30 MHz.

### Resonant Antenna 23A

The resonant antenna 23A is the electronic component that makes it possible to receive the radiofrequency signal.

The resonant antenna 23A has a high quality factor, preferably greater than or equal to 80.

The resonant antenna 23A is configured to receive a radiofrequency signal at a precise frequency, for example 14 MHz, corresponding to the resonant frequency of the resonant antenna 13A present in the high-frequency antenna module 13 of the vehicle 10.

The high quality factor and precise resonant frequency ensure that the high-frequency signals transmitted by the high-frequency antenna module 13 and received by the high-frequency antenna module 23 have a high signal-to-noise ratio at a distance of approximately 2 meters.

### Exemplary Implementation

In a manner known per se, after the user has left the vehicle 10, the locking system 14 blocks the opening elements of the vehicle 10 to prevent intrusion.

In order to detect the return of the user, the vehicle 10 periodically transmits detection signals with a range of a few meters, in order to detect the device 20 carried by the user.

When the user approaches the vehicle 10, the device 20 receives these radiofrequency detection signals.

The method according to the invention begins when the device 20 has received the detection signals transmitted by the vehicle 10 and is therefore located at a predetermined distance from the vehicle 10.

In a first step E1, the control module 21 of the device 20 generates a high-frequency signature request.

This request comprises the values of the characteristics of the expected high-frequency signature.

Preferably, the expected high-frequency signature is a square-wave signal or a PWM signal, and its characteristics comprise the number of square waves, their duration and/or their spacing.

In step E1, the control module 21 also starts a timer.

Advantageously, the control module 21 encrypts the high-frequency signature request.

In a second step E2, the high-frequency signature request is transmitted to the radiofrequency antenna module 22 of the device 20, which transmits it in the form of a radiofrequency signal.

In a third step E3, the high-frequency signature request is received by the radiofrequency antenna module 12 of the vehicle 10.

In a fourth step E4, the radiofrequency antenna module 12 sends the high-frequency signature request to the electronic control unit 11.

Advantageously, the electronic control unit 11 decrypts the high-frequency signature request if it has been encrypted beforehand by the control module 21.

In a step E5, the electronic control unit 11 generates a high-frequency signature the characteristics of which correspond to those of the received high-frequency signature request.

In a step E6, the high-frequency signature is transmitted to the high-frequency antenna module 13 of the vehicle 10. The high-frequency signature is then transmitted in the form of a high-frequency signal by the resonant antenna 13A.

In a step E7, the high-frequency signature is received by the high-frequency antenna module 23 of the device 20.

The high-frequency signature is received via the resonant antenna 13A. This resonant antenna 13A resonates at a precise frequency corresponding to the resonant frequency of the resonant antenna 23A of the device 20.

The information in the high-frequency signature received by the device 20 is thus complete and of high quality because the two resonant antennas 13A, 23A have a high quality factor.

The high quality factor of the resonant antennas 13A, 23A allows a longer range, at approximately 2 meters, of the high-frequency signals at the frequency of the resonant antennas 13A, 23A. Outside this precise frequency, the high-frequency signals would have a much shorter range, of the order of a few centimeters.

The high-frequency signals thus have a shorter range than the radiofrequency signals transmitted and received by the radiofrequency antenna modules 12, 22. A third party therefore has to be located close to the device 20 and/or the vehicle 10 if they wish to capture the high-frequency signature, which prevents them from being discreet.

In addition, if the third party is not using a resonant antenna at the correct frequency corresponding to those of the resonant antennas 13A, 23A, they also have to approach the vehicle 10 or the device 20 to within the order of a few centimeters in order to be able to intercept the exchanges of high-frequency signals.

In a step E8, the control module 21 receives the high-frequency signature via the high-frequency antenna module 23 of the device 20.

Upon receipt of the high-frequency signature, the control module 21, in a step E9, stops the timer started in step E1 and compares it with the stored reference time.

If a third party seeks to capture the high-frequency signature through a relay attack, the delay between the transmission of the high-frequency signature request and the receipt of the high-frequency signature will be longer than in a legitimate exchange. A longer delay will therefore indicate a fraudulent attempt.

In a step E10, the control module 21 analyzes the received high-frequency signature by comparing its characteristics with those corresponding to the request generated in step E5.

The analysis carried out by the control module 21 also relates to the quality of the signal forming the high-frequency signature. Because of the resonant antennas 13A and 23A, the expected signal is of high quality, that is to say the signal contains little noise compared to the “payload” signal. If a third party seeks to capture the high-frequency signature using an antenna that does not match the resonant frequency of the resonant antenna 23A, the signal will be severely degraded and will therefore indicate a fraudulent attempt.

If the characteristics match, the control module 21, in a step E11, generates a signal comprising the identifier and sends it to the radiofrequency antenna module 22.

In a step E12, the radiofrequency antenna module 22 transmits a radiofrequency signal comprising the identifier.

In a step E13, the signal comprising the identifier is received by the electronic control unit 11 via the radiofrequency antenna module 12 of the vehicle 10.

In this step, the electronic control unit 11 checks, in its memory, whether a high-frequency signature request has been received beforehand and/or a high-frequency signature has been generated beforehand. If there is no instance of receipt or generation in memory, a fraudulent attempt is detected and the electronic control unit 11 does not send a signal to the locking system 14.

If there is an instance of receipt and/or generation in memory, the electronic control unit 11, in a step E14, sends a signal comprising the identifier to the locking system 14, said signal triggering the release of the opening elements of the vehicle 10.

The user is thus able to open one of the opening elements of the vehicle 10 when they arrive, without having to carry out any additional action.

Since the transmission of the signal comprising the identifier is triggered when the device 20 carried by the user is close to the vehicle 10, any third party seeking to fraudulently capture this identifier has less chance to place a capture device.

Moreover, the transmission of the identifier is conditional upon the presence of a high-frequency signature exchange beforehand.

If a third party sends a signal to the device 20 seeking to automatically trigger sending of the identifier, the device 20, not having received a high-frequency signature beforehand, will not transmit the identifier.

Similarly, if a third party who has managed to capture the identifier sends this identifier to the vehicle 10 in the absence of a high-frequency signature being sent beforehand, the electronic control unit 11 may thus block the signal and not send it to the locking system 14, avoiding the opening elements being opened.

Finally, a third party may attempt to carry out a relay attack by causing a high-frequency signature request to be sent and by capturing this request so as to retransmit it in the vicinity of the vehicle 10 in order to capture the high-frequency signature.

Firstly, if the third party does not have a resonant antenna at the correct frequency, the signal will be of inferior quality and will not make it possible to trigger sending of the identifier.

Secondly, the capture and retransmission would cause a latency in the receipt of the high-frequency signature, which the control module 21 may interpret as a fraudulent attempt, thus blocking sending of the identifier.

1. A method for securing the transmission of the identifier of a portable device for accessing a motor vehicle, said vehicle comprising an electronic control unit, a radiofrequency antenna module and a high-frequency antenna module operating in a frequency band distinct from the frequency band of the radiofrequency antenna module, said device comprising a control module, a radiofrequency antenna module and a high-frequency antenna module, said control module comprising a memory area in which the identifier of said device is stored, said method comprising:
the control module of the device commanding transmission of a high-frequency signature request via the radiofrequency antenna module of the device, said high-frequency signature request comprising the characteristics of said signature,
the electronic control unit receiving the high-frequency signature request via the radiofrequency antenna module of the vehicle,
the electronic control unit generating a high-frequency signature containing the characteristics,
sending the generated high-frequency signature to the device via the high-frequency antenna module of the vehicle,
the control module receiving the sent high-frequency signature via the high-frequency antenna module of the device,
the control module analyzing the received high-frequency signature,
when the high-frequency signature has the characteristics sent in the high-frequency signature request, the control module sending a signal containing the identifier via the radiofrequency antenna module of the device, the electronic control unit receiving the sent signal via the radiofrequency antenna module of the vehicle, the electronic control unit identifying the device and activating a function of the vehicle once the device has been identified.

2. The method as claimed in claim 1, wherein the vehicle comprises a locking system connected to the electronic control unit and wherein the function of the vehicle activated in the step of identifying the device is that of unlocking the locking system of the vehicle.

3. The method as claimed in claim 1, wherein the control module triggers a timer when the high-frequency signature request is sent, stops the timer when the high-frequency signature is received, compares the time thus measured with a reference time and triggers the step of analyzing the signature only if the measured time is less than the reference time.

4. The method as claimed in claim 1, wherein the values of the characteristics of the high-frequency signature request are generated randomly each time the method is implemented.

5. The method as claimed in claim 1, wherein the high-frequency signature is a square-wave signal the characteristics of which comprise the number of square waves, their duration and/or their spacing.

6. The method as claimed in claim 1, wherein the high-frequency antenna module of the vehicle and the high-frequency antenna module of the device each comprise a high-frequency antenna, the two antennas being mutually resonant.

7. A device comprising a control module, a radiofrequency antenna module and a high-frequency antenna module operating in a frequency band distinct from the frequency band of the radiofrequency antenna module, said control module comprising a memory area in which an identifier is stored and being configured to:
be connected to the radiofrequency antenna module and to the high-frequency antenna module in the device,
command transmission of a high-frequency signature request via the radiofrequency antenna module, said high-frequency signature request comprising the characteristics of said high-frequency signature,
receive a sent high-frequency signature via the high-frequency antenna module,
analyze the received high-frequency signature,
when the high-frequency signature has the characteristics sent in the high-frequency signature request, send a signal containing the identifier via the radiofrequency antenna module of the device.

8. An electronic control unit for a motor vehicle, said electronic control unit being configured to:
be connected to a radiofrequency antenna module and a high-frequency antenna module operating in a frequency band distinct from the frequency band of the radiofrequency antenna module,
receive a high-frequency signature request via the radiofrequency antenna module of the vehicle, said high-frequency signature request comprising the characteristics of said signature,
generate a high-frequency signature containing the characteristics,
send the generated high-frequency signature via the high-frequency antenna module of the vehicle,
receive a signal containing the identifier via the radiofrequency antenna module of the vehicle,
identify the identifier and activate a function of the vehicle.

9. A vehicle comprising an electronic control unit as claimed in claim 8, a radiofrequency antenna module and a high-frequency antenna module.

10. A system comprising a vehicle as claimed in claim 9 and a device comprising:
a control module, a radiofrequency antenna module and a high-frequency antenna module operating in a frequency band distinct from the frequency band of the radiofrequency antenna module, said control module comprising a memory area in which an identifier is stored and being configured to:
be connected to the radiofrequency antenna module and to the high-frequency antenna module in the device,
command transmission of a high-frequency signature request via the radiofrequency antenna module, said high-frequency signature request comprising the characteristics of said high-frequency signature,
receive a sent high-frequency signature via the high-frequency antenna module, analyze the received high-frequency signature, and
when the high-frequency signature has the characteristics sent in the high-frequency signature request, send a signal containing the identifier via the radiofrequency antenna module of the device.
